(19) United States
(12) Patent Application Publication
(10) Pub. No.: US 2025/0294418 A1
(43) Pub. Date: Sep. 18, 2025

(54) AMBIENT INTERNET OF THINGS DEVICE HANDOVER

(71) Applicant: QUALCOMM Incorporated, San Diego, CA (US)

(72) Inventors: Mohammad Tarek FAHIM, San Diego, CA (US); Marwen ZORGUI, San Diego, CA (US); Mohammed Ali Mohammed HIRZALLAH, San Marcos, CA (US); Ahmed ELSHAFIE, San Diego, CA (US)

(21) Appl. No.: 18/603,796

(22) Filed: Mar. 13, 2024

(51) Int. Cl. H04W 36/00; H04B 7/22; H04W 84/18

(52) U.S. Cl. CPC H04W 36/035; H04B 7/22; H04W 84/18

(57) ABSTRACT

Various aspects of the present disclosure generally relate to wireless communication. In some aspects, a network node may transmit, and a user equipment (UE) may receive, a measurement configuration message. For example, the measurement configuration message may indicate a backscattered signal level threshold and/or a time period associated with the backscattered signal level. In response to receiving the measurement configuration message, the UE may transmit a measurement report. The measurement report may initiate a handover of an ambient internet of things (IoT) device. For example, in response to receiving the measurement report, the network node may transmit an ambient IoT device handover request. For example, the network node may transmit the ambient IoT device handover request to a target UE and/or a target cell.

### FIELD OF THE DISCLOSURE

Aspects of the present disclosure generally relate to wireless communication and specifically, to techniques and apparatuses for ambient internet of things (IoT) device handover.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipment (UEs) to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In topology 2 for ambient internet of things (IoT) devices, an ambient IoT device may communicate bidirectionally with an intermediate node between the ambient IoT device and a base station. In some instances, the ambient IoT device and/or the intermediate node in topology 2 may be mobile, which can impede network connectivity of the ambient IoT device. In some scenarios, the ambient IoT device can move away from the intermediate node. In some scenarios, the intermediate node can move away from the ambient IoT device. As a result, distance between the intermediate node and the ambient IoT device may increase, thereby impeding communications between the intermediate node and the ambient IoT device. In some scenarios, the intermediate node and the ambient IoT device can jointly move away from a serving cell, thereby impeding communications between the serving cell and the intermediate node (and, thus, the ambient IoT device).

### SUMMARY

Some aspects described herein relate to an apparatus for wireless communication at a user equipment (UE). The apparatus may include one or more memories storing processor-executable code and one or more processors coupled with the one or more memories. At least one processor of the one or more processors may be configured to cause the UE to receive a backscattered signal associated with an ambient internet of things (IoT) device, wherein the UE is configured to transfer information between the ambient IoT device and a network node. At least one processor of the one or more processors may be configured to cause the UE to initiate a handover of the ambient IoT device.

Some aspects described herein relate to an apparatus for wireless communication at a network node. The apparatus may include one or more memories storing processor-executable code and one or more processors coupled with the one or more memories. At least one processor of the one or more processors may be configured to cause the network node to receive a measurement report from a UE configured to transfer information between an ambient IoT device and the network node. At least one processor of the one or more processors may be configured to cause the network node to transmit, in accordance with the measurement report, an ambient IoT device handover request.

Some aspects described herein relate to a method of wireless communication performed at a UE. The method may include receiving a backscattered signal associated with an ambient IoT device, wherein the UE is configured to transfer information between the ambient IoT device and a network node. The method may include initiating a handover of the ambient IoT device.

Some aspects described herein relate to a method of wireless communication performed at a network node. The method may include receiving a measurement report from a UE configured to transfer information between an ambient IoT device and the network node. The method may include transmitting, in accordance with the measurement report, an ambient IoT device handover request.

Some aspects described herein relate to a non-transitory computer-readable medium that stores a set of instructions for wireless communication. The set of instructions comprise one or more instructions that, when executed by one or more processors of a UE, may cause the UE to receive a backscattered signal associated with an ambient IoT device, wherein the UE is configured to transfer information between the ambient IoT device and a network node. The one or more instructions, when executed by one or more processors of the UE, may cause the UE to initiate a handover of the ambient IoT device.

Some aspects described herein relate to a non-transitory computer-readable medium that stores a set of instructions for wireless communication. The set of instructions comprise one or more instructions that, when executed by one or more processors of a network node, may cause the network node to receive a measurement report from a UE configured to transfer information between an ambient IoT device and the network node. The one or more instructions, when executed by one or more processors of the network node, may cause the network node to transmit, in accordance with the measurement report, an ambient IoT device handover request.

Some aspects described herein relate to an apparatus for wireless communication. The apparatus may include means for receiving a backscattered signal associated with an ambient IoT device, wherein the UE is configured to transfer information between the ambient IoT device and a network node. The apparatus may include means for initiating a handover of the ambient IoT device.

Some aspects described herein relate to an apparatus for wireless communication. The apparatus may include means for receiving a measurement report from a UE configured to transfer information between an ambient IoT device and the network node. The apparatus may include means for transmitting, in accordance with the measurement report, an ambient IoT device handover request.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example network node in communication with a user equipment (UE) in a wireless network.

FIG. 3 is a diagram illustrating an example associated with backscatter communications.

FIG. 4 is a diagram illustrating examples of topologies for ambient internet of things (IoT) devices.

FIG. 5 is a diagram illustrating an example associated with ambient IoT device handover.

FIG. 6 is a diagram illustrating an example of a first scenario associated with ambient IoT device handover.

FIG. 7 is a diagram illustrating an example of a second scenario associated with ambient IoT device handover.

FIG. 8 is a diagram illustrating an example of a third scenario associated with ambient IoT device handover.

FIG. 9 is a flowchart illustrating an example process performed, for example, at a UE or an apparatus of a UE that supports ambient IoT device handover.

FIG. 10 is a flowchart illustrating an example process performed, for example, at a network node or an apparatus of a network node that supports ambient IoT device handover.

FIG. 11 is a diagram of an example apparatus for wireless communication that supports ambient IoT device handover.

FIG. 12 is a diagram of an example apparatus for wireless communication that supports ambient IoT device handover.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some wireless communication devices may be considered internet of things (IoT) devices, such as ambient IoT devices (sometimes referred to as ultra-light IoT devices), or similar IoT devices. In ambient IoT, a terminal (for example, a radio frequency identification (RFID) device, a tag, or a similar device) may not include a battery, and the terminal may accumulate energy from radio signaling. To achieve further cost reduction and zero-power communication, wireless networks may utilize a type of ambient IoT device referred to as an “ambient backscatter device” or a “backscatter device.” Various topologies may be defined for ambient IoT devices.

In one such topology, which may be referred to as topology 2, an ambient IoT device may communicate bidirectionally with an intermediate node between the ambient IoT device and a base station. In some instances, the ambient IoT device and/or the intermediate node in topology 2 may be mobile, which can impede network connectivity of the ambient IoT device. For example, in a scenario where the intermediate node is stationary and the ambient IoT device is moving, the ambient IoT device may move away from the intermediate node. In a scenario where the intermediate node is mobile and the ambient IoT device is stationary, the intermediate node may move away from the ambient IoT device. In both scenarios, distance between the intermediate node and the ambient IoT device may increase, thereby impeding communications between the intermediate node and the ambient IoT device. In a scenario where the intermediate node and the ambient IoT device are both mobile, the intermediate node and the ambient IoT device may move away from a serving cell, thereby impeding communications between the serving cell and the intermediate node (and, thus, the ambient IoT device).

Various aspects relate generally to ambient IoT device handover and to topology 2 scenarios where the ambient IoT device and/or the intermediate node (for example, a UE) are mobile. In some scenarios, the UE may be a stationary device and the ambient IoT device may be a mobile device. In some scenarios, the UE may be a mobile device and the ambient IoT device may be a stationary device. In some scenarios, the UE may be a mobile device and the ambient IoT device may be a mobile device.

In some aspects, the network node may transmit, and the UE may receive, a measurement configuration message. For example, the measurement configuration message may indicate a backscattered signal level threshold and/or a time period associated with the backscattered signal level. In response to receiving the measurement configuration message, the UE may transmit a measurement report. The measurement report may initiate (e.g., prompt) a handover of the ambient IoT device. For example, in response to receiving the measurement report, the network node may transmit an ambient IoT device handover request. For example, the network node may transmit the ambient IoT device handover request to a target UE and/or a target cell.

Particular aspects of the subject matter described in this disclosure can be implemented to realize one or more of the following potential advantages. In some examples, by initiating (e.g., prompting) the handover of the ambient IoT device (for example, by transmitting the ambient IoT device handover request), the described techniques can be used to maintain network connectivity for the ambient IoT device. For example, the ambient IoT device may maintain network connectivity under various scenarios of topology 2 in which the ambient IoT device and/or the UE are mobile. In some examples, the ambient IoT device may maintain network connectivity in scenarios where the UE is a stationary device, and the ambient IoT device is a mobile device. In some examples, the ambient IoT device may maintain network connectivity in scenarios where the UE is a mobile device, and the ambient IoT device is a stationary device. In some examples, the ambient IoT device may maintain network connectivity in scenarios where the UE is a mobile device and the ambient IoT device is a mobile device.

The measurement configuration message indicating the backscattered signal level threshold may enable the UE to transmit the measurement report in response to the backscattered signal level not satisfying the backscattered signal level threshold, which may further conserve overhead. For example, the UE may refrain from transmitting the measurement report if the backscattered signal level satisfies (for example, is greater than) the backscattered signal level threshold.

The measurement configuration message indicating the time period associated with the backscattered signal level may help to ensure that the UE collects a sufficient sample size when monitoring the backscattered signal level before transmitting the measurement report, which may further conserve overhead and/or improve network connectivity of the ambient IoT device. For example, the UE may refrain from transmitting the measurement report if the backscattered signal level temporarily dips below the backscattered signal level threshold.

Transmitting the ambient IoT device handover request to the target UE may further conserve overhead by enabling the network node to avoid establishing a different configuration for the ambient IoT device on a target cell. Transmitting the ambient IoT device handover request to the target cell may enable the ambient IoT device to maintain network connectivity if no target UEs are available in the serving cell of the network node to serve the ambient IoT device.

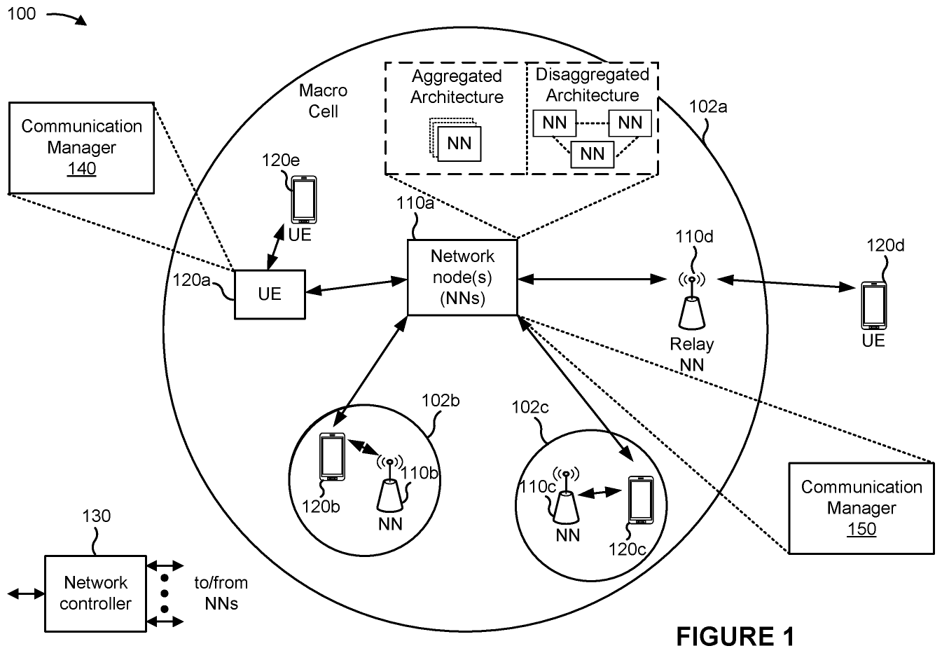

FIG. 1 is a diagram illustrating an example of a wireless network. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120c), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell (for example, macro cell 102a), a pico cell (for example, pico cell 102b), a femto cell (for example, femto cell 102c), or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses (for example, an augmented reality (AR), virtual reality (VR), mixed reality, or extended reality (XR) headset), a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium. Some UEs 120 (for example, UEs 120a and 120c) may communicate directly using one or more sidelink channels (for example, without a network node as an intermediary to communicate with one another).

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered IoT devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In some examples, two or more UEs 120 (for example, shown as UE 120a and UE 120c) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol using for example a PC5 interface for direct communication, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110. In other examples, the two or more UEs 120 may communicate through a vehicle-to-network-vehicle (V2N2V) protocol for example by communicating through a Uu interface using the LTE and/or NR uplink and downlink.

In some aspects, the UE 120 may include a communication manager 140. As described in more detail elsewhere herein, the communication manager 140 may receive a backscattered signal associated with an ambient IoT device, wherein the UE 120 is configured to transfer information between the ambient IoT device and the network node 110; and initiate a handover of the ambient IoT device. Additionally or alternatively, the communication manager 140 may perform one or more other operations described herein.

In some aspects, the network node 110 may include a communication manager 150. As described in more detail elsewhere herein, the communication manager 150 may receive a measurement report from the UE 120 configured to transfer information between an ambient IoT device and the network node 110; and transmit, in accordance with the measurement report, an ambient IoT device handover request. Additionally or alternatively, the communication manager 150 may perform one or more other operations described herein.

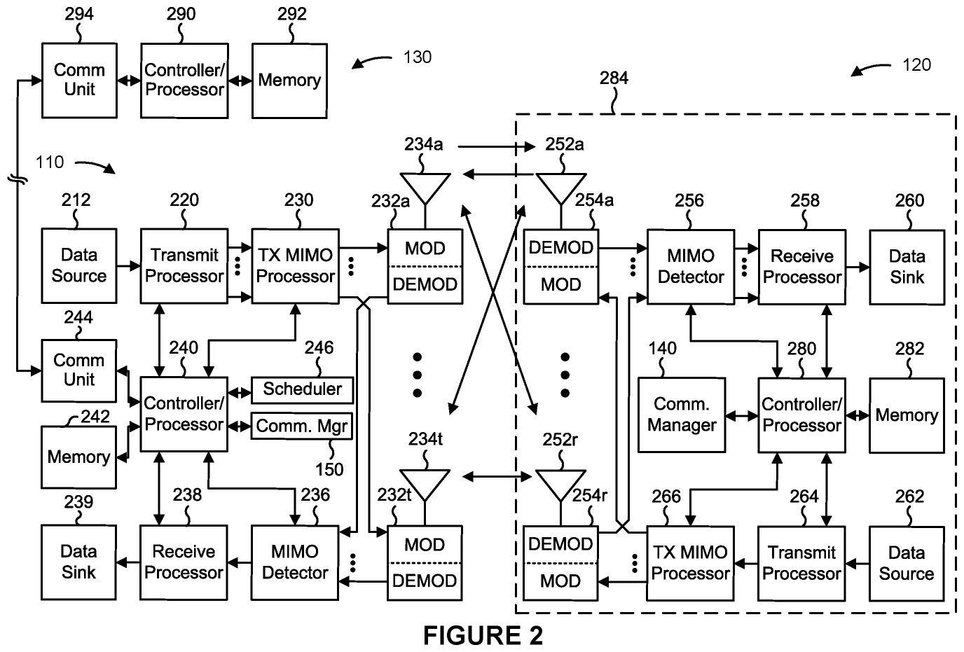

FIG. 2 is a diagram illustrating an example network node in communication with a UE in a wireless network. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 (for example, one or more memories) to perform aspects of any of the methods described herein.

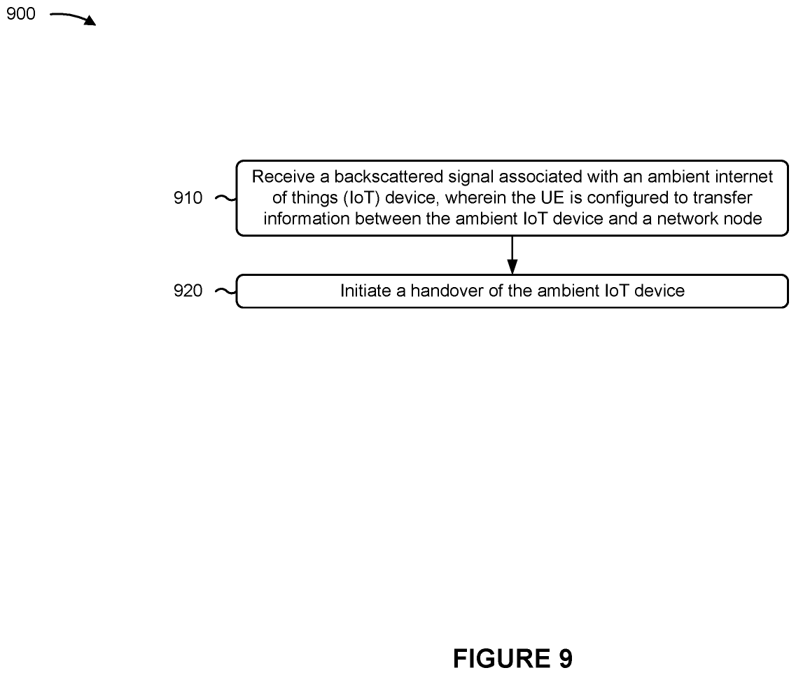

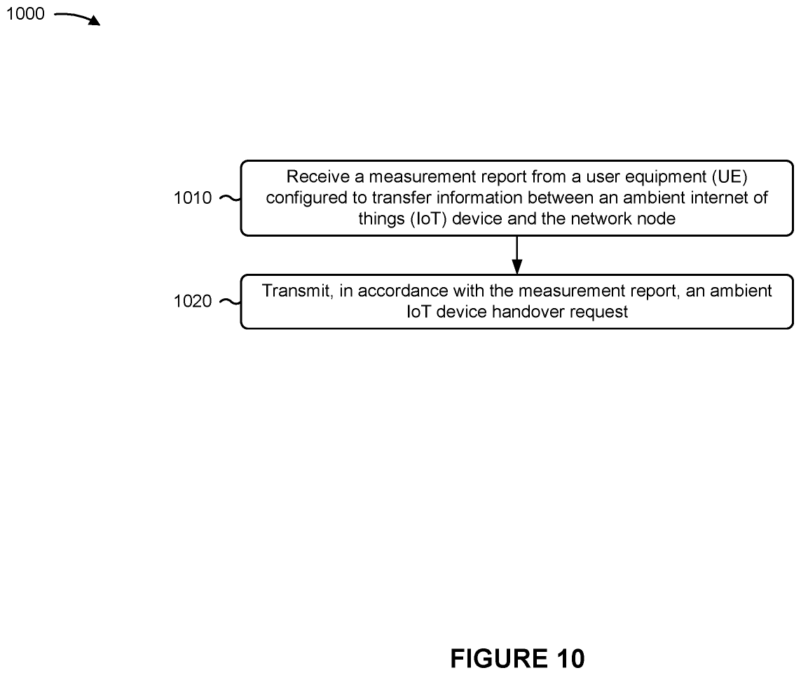

The controller/processor 240 of the network node 110, the controller/processor 280 of the UE 120, or any other component(s) of FIG. 2 may perform one or more techniques associated with ambient IoT device handover, as described in more detail elsewhere herein. For example, the controller/processor 240 of the network node 110, the controller/processor 280 of the UE 120, or any other component(s) of FIG. 2 may perform or direct operations of, for example, process 900 of FIG. 9, process 1000 of FIG. 10, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 900 of FIG. 9, process 1000 of FIG. 10, or other processes as described herein. In some examples, executing instructions may include running the instructions, converting the instructions, compiling the instructions, or interpreting the instructions, among other examples. In some implementations, one or more of the multiple memories may be configured to store processor-executable code that, when executed, may configure the one or more processors to perform various functions described herein (as part of a processing system). In some other implementations, the processing system may be pre-configured to perform various functions described herein.

In some aspects, an individual processor may perform all of the functions described as being performed by one or more processors. In some aspects, one or more processors may collectively perform (or be configured or operable to perform) a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

In some aspects, the UE 120 includes means for receiving a backscattered signal associated with an ambient IoT device, wherein the UE 120 is configured to transfer information between the ambient IoT device and the network node 110; and/or means for initiating a handover of the ambient IoT device. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for receiving a measurement report from the UE 120 configured to transfer information between an ambient IoT device and the network node 110; and/or means for transmitting, in accordance with the measurement report, an ambient IoT device handover request. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

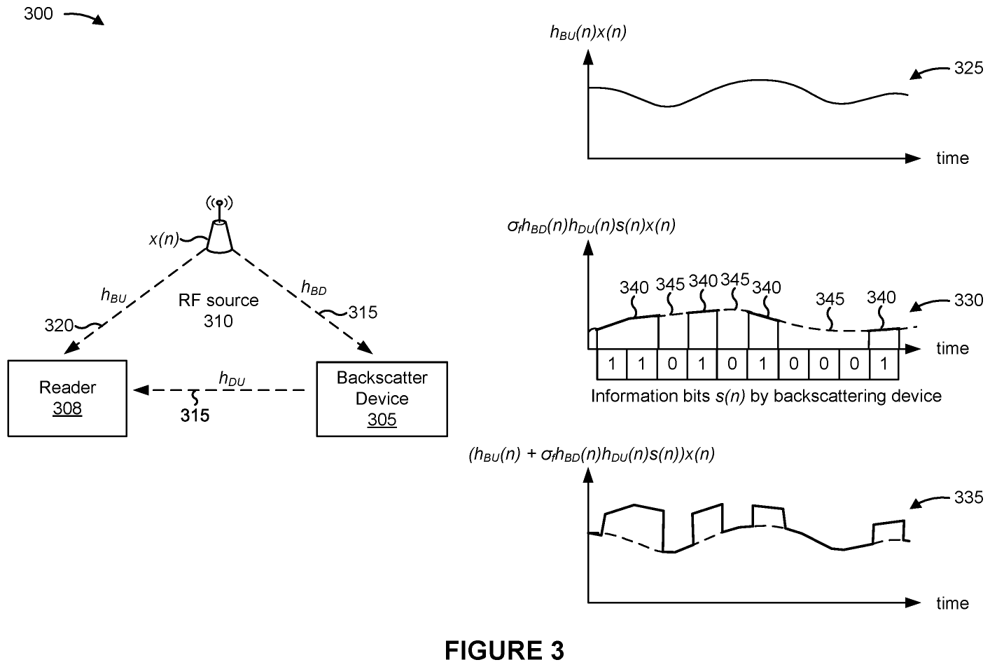

FIG. 3 is a diagram illustrating an example 300 associated with backscatter communications.

Some wireless communication devices may be considered IoT devices, such as ambient IoT devices (sometimes referred to as ultra-light IoT devices), or similar IoT devices. In ambient IoT, a terminal (for example, an RFID device, a tag, or a similar device) may not include a battery, and the terminal may accumulate energy from radio signaling. To achieve further cost reduction and zero-power communication, wireless networks may utilize a type of ambient IoT device referred to as an “ambient backscatter device” or a “backscatter device.”

As shown in FIG. 3, a backscatter device 305 (for example, a tag or a sensor, among other examples), which may be one example of an ambient IoT device, may employ a simplified hardware design (for example, including a power splitter, an energy harvester, and a microcontroller) that does not include a battery, such that the backscatter device 305 relies on energy harvesting for power, and that does not include a radio wave generation circuit, such that the backscatter device 305 is capable of transmitting information only by reflecting a radio wave. More particularly, the backscatter device 305 communicates with a reader 308 (for example, a UE 120, a network node 110, or another network device) by modulating a reflecting radio signal from a radio frequency (RF) source 310 (for example, a network node 110, a UE 120, or another network device). In some examples, the RF source 310 and the reader 308 may be the same device and/or may be co-located. For example, in some instances, the reader 308 and the RF source 310 may be associated with the same network node 110.

To facilitate communication of the backscatter device 305, the RF source 310 may transmit an energy harvesting wave to the backscatter device 305. The energy harvesting wave may be transmitted for a sufficient duration in order to enable a communication phase for a target range between the reader 308 and the backscatter device 305. Additionally or alternatively, in some instances, a range between the RF source 310 and the backscatter device 305 may be limited by a minimum received power for triggering energy harvesting at the backscatter device 305, such as −20 decibel milliwatts (dBm).

Once energy is sufficiently accumulated at the backscatter device 305, the backscatter device 305 may begin to reflect the radio wave that is radiated onto the backscatter device 305 via a backscatter link 315. For example, the RF source 310 may initiate a communication session (sometimes referred to as a query-response communication) with a query, which may be a modulating envelope of a continuous wave (CW). The backscatter device 305 may respond by backscattering of the CW. The communication session may include multiple rounds, such as for purposes of contention resolution when multiple backscatter devices respond to a query. A channel between the RF source 310 and the backscatter device 305 of the backscatter link 315 may be associated with a first backscatter link channel response value (sometimes referred to as a first backscatter link channel coefficient or a first backscatter link gain value), hBD. As described below, the backscatter device 305 may have reflection-on periods and reflection-off periods that follow a pattern that is based at least in part on the transmission of information bits by the backscatter device 305. The reader 308 may detect the reflection pattern of the backscatter device 305 and obtain the backscatter communication information via the backscatter link 315. A channel between the reader 308 and the backscatter device 305 of the backscatter link 315 may be associated with a second backscatter link channel response value (sometimes referred to as a second backscatter link channel coefficient or a second backscatter link channel gain value), hDU. In addition, the RF source 310 and the reader 308 may communicate (for example, reference signals and/or data signals) via a direct link 320. A channel between the RF source 310 and the reader 308 of the direct link 320 may be associated with a direct link channel response value (sometimes referred to as a direct link channel coefficient or a direct link channel gain value), hBU.

The backscatter device 305 may use an information modulation scheme, such as amplitude shift keying (ASK) modulation or on-off keying (OOK) modulation. For ASK or OOK modulation, the backscatter device 305 may switch on reflection when transmitting an information bit “1” and switch off reflection when transmitting an information bit “0.” In backscatter communication, the RF source 310 may transmit a particular radio wave (for example, a reference signal or a data signal, such as a physical downlink shared channel (PDSCH)), which may be denoted as x(n). The reader 308 may receive this radio wave, x(n), directly from the RF source 310 via the direct link 320, as well as from the backscatter device 305 modulating and reflecting the radio wave to the reader 308 via the backscatter link 315. The signal received at the reader 308 via the direct link 320, indicated by reference number 325, is the product of the radio wave transmitted by the RF source 310, x(n), multiplied by the direct link channel response value, hBU, plus any signal noise. The information bits signal of the backscatter device 305 may be denoted as s(n) where s(n)∈{0,1}. Accordingly, the signal received at the reader 308 via the backscatter link 315, indicated by reference number 330, is the product of the signal transmitted by the RF source 310, x(n), multiplied by the first backscatter link channel response value, hBD, the second backscatter link channel response value, hDU, the information bits signal from the backscatter device 305, s(n), and a reflection coefficient associated with the backscatter device 305 plus any noise.

Thus, the resulting signal received at the reader 308, which is the superposition of the signal received via the direct link 320 and the signal received via the backscatter link 315, may be denoted as y(n). This signal, y(n), is shown by reference number 335. As shown, when s(n)=0 (indicated by reference number 340 in the plot shown at reference number 330), the backscatter device 305 may switch off reflection, and thus the reader 308 receives only the direct link 320 signal. When s(n)=1 (indicated by reference number 345 in the plot shown at reference number 330), the backscatter device 305 may switch on reflection, and thus the reader 308 receives a superposition of both the direct link 320 signal and the backscatter link 315 signal. To receive the information bits transmitted by the backscatter device 305, the reader 308 may first decode x(n) based at least in part on the direct link channel response value of h_BU (n) by treating the backscatter link 315 signal as interference. The reader 308 may then detect the existence of the signal component. In some instances, the backscatter device 305 may not maintain a state from communication session to communication session except of what is stored in the backscatter device 305 memory, such as an electronic product code (EPC) associated with backscatter device 305 or similar information.

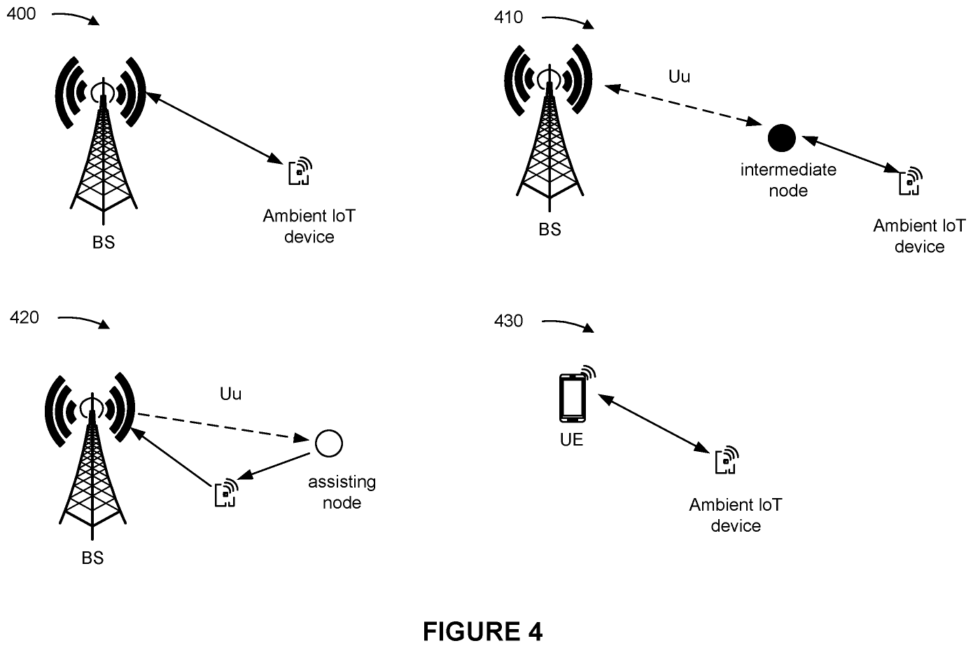

FIG. 4 is a diagram illustrating examples 400-440 of topologies for ambient IoT devices.

Example 400 relates to a first topology, which may be referred to as topology 1. In topology 1, an ambient IoT device may directly and bidirectionally communicate with one or more base stations. For example, the ambient IoT device and the one or more base stations may communicate ambient IoT data and/or signaling. In some examples, a first base station may transmit communications to the ambient IoT device and a second base station may receive communications from the ambient IoT device.

Example 410 relates to a second topology, which may be referred to as topology 2. In topology 2, the ambient IoT device may communicate bidirectionally with an intermediate node between the ambient IoT device and a base station. The intermediate node may be any suitable device that is capable of ambient IoT, such as a relay, IAB node, UE, or repeater, among other examples. The intermediate node may transfer ambient IoT data and/or signaling between base station and the ambient IoT device.

Example 420 relates to a third topology, which may be referred to as topology 3. In some examples, in topology 3, the ambient IoT device may transmit ambient IoT data and/or signaling to a base station and receive ambient IoT data and/or signaling from an assisting node. In some examples, in topology 3, the ambient IoT device may receive ambient IoT data and/or signaling from the base station and transmit ambient IoT data and/or signaling to the assisting node. The assisting node may be any suitable device that is capable of ambient IoT, such as a relay, IAB node, UE, or repeater, among other examples.

Example 430 relates to a fourth topology, which may be referred to as topology 4. In topology 4, an ambient IoT device may bidirectionally communicate with a UE. For example, the ambient IoT device and the UE may communicate ambient IoT data and/or signaling.

As indicated above, FIG. 4 is provided as an example. Other examples may differ from what is described with respect to FIG. 4.

In some instances, one or more entities in topology 2 may be mobile, which can impede network connectivity of the ambient IoT device. For example, in a scenario where the intermediate node (for example, a UE) is stationary and the ambient IoT device is moving, the ambient IoT device may move away from the intermediate node. In a scenario where the intermediate node is mobile and the ambient IoT device is stationary, the intermediate node may move away from the ambient IoT device. In both scenarios, distance between the intermediate node and the ambient IoT device may increase, thereby impeding communications between the intermediate node and the ambient IoT device. In a scenario where the intermediate node and the ambient IoT device are both mobile, the intermediate node and the ambient IoT device may move away from a serving cell, thereby impeding communications between the serving cell and the intermediate node (and, thus, the ambient IoT device).

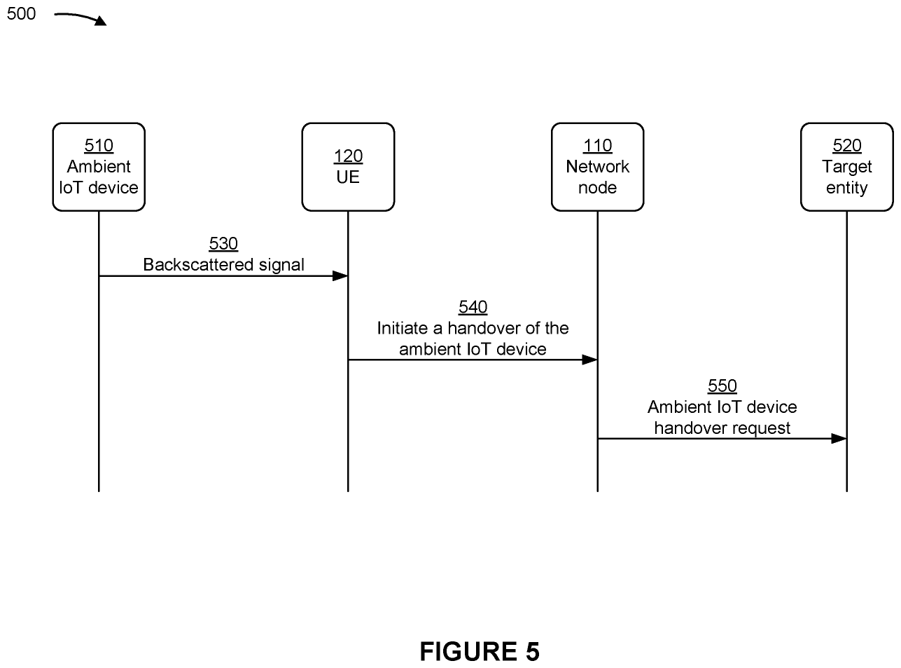

FIG. 5 is a diagram illustrating an example 500 associated with ambient IoT device handover. As shown in FIG. 5, example 500 includes communication between a network node 110, a UE 120, an ambient IoT device 510, and a target entity 520. The network node 110 may be a serving cell for the UE 120 and/or the ambient IoT device 510.

In some examples, the UE 120 may be configured to transfer information (for example, ambient IoT data and/or signaling) between the ambient IoT device 510 and a network node 110. For example, the network node 110, the UE 120, and the ambient IoT device 510 may be arranged in accordance with topology 2. For example, the UE 120 may bidirectionally communicate with the ambient IoT device 510 and the network node 110 by acting as both a transmitter and a receiver. In some examples, the UE 120 may be a monostatic UE reader acting as an intermediate node between the ambient IoT device 510 and the network node 110 (for example, a base station).

In a first operation 530, the ambient IoT device 510 may transmit, and the UE 120 may receive, a backscattered signal associated with the ambient IoT device 510. The backscattered signal may be associated with the ambient IoT device 510 in that the backscattered signal may be backscattered by the ambient IoT device 510. In some examples, the UE 120 may transmit a signal (for example, a radio wave) that the ambient IoT device 510 backscatters.

In a second operation 540, the UE 120 may initiate (e.g., prompt) a handover of the ambient IoT device 510. For example, the UE 120 may initiate a handover of the ambient IoT device 510 to the target entity 520, such as a target UE or a target cell. In some examples, the UE 120 may transmit a measurement report that initiates the handover of the ambient IoT device 510, and the network node 110 may receive the measurement report from the UE 120. The measurement report may be an ambient IoT measurement report that indicates a backscattered signal level or a UE handover measurement report, among other examples.

In a third operation 550, the network node 110 may transmit, in accordance with the measurement report, and the target entity 520 may receive, an ambient IoT device handover request. For example, the network node 110 may transmit the ambient IoT device handover request in response to receiving the measurement report. The ambient IoT device handover request may be a request to handover the ambient IoT device 510 from the network node 110 and/or the UE 120 to the target entity 520.

In some aspects, a plurality of UEs, including the UE 120, may be configured to serve the ambient IoT device 510. For example, the plurality of UEs may concurrently monitor the ambient IoT device 510 (for example, to track positioning of the ambient IoT device 510). The network node 110 may transmit, in association with the plurality of measurement reports and a quantity of the plurality of UEs, a request for another UE to serve the ambient IoT device 510. For example, the network node 110 may track the quantity of the plurality of UEs using the plurality of measurement reports and transmit a request to add the other UE to the plurality of UEs configured to serve the ambient IoT device 510.

In some aspects, a network entity may transmit (for example, report), and the network node 110 may receive, a configuration of a UE minimum quantity threshold. The network entity may be a core network entity, such as an access and mobility management function (AMF). The UE minimum quantity threshold may be a threshold such that, if not satisfied by a quantity of the plurality of UEs configured to serve the ambient IoT device 510, the network node 110 may transmit the request for the other UE to serve the ambient IoT device 510. For example, the network node 110 may transmit the request for the other UE to serve the ambient IoT device 510 responsive to the quantity of the plurality of UEs not satisfying the UE minimum quantity threshold. For example, the network node 110 may transmit the request for the other UE to serve the ambient IoT device 510 if the quantity of UEs is a minimum quantity that is equal to or below the UE minimum quantity threshold.

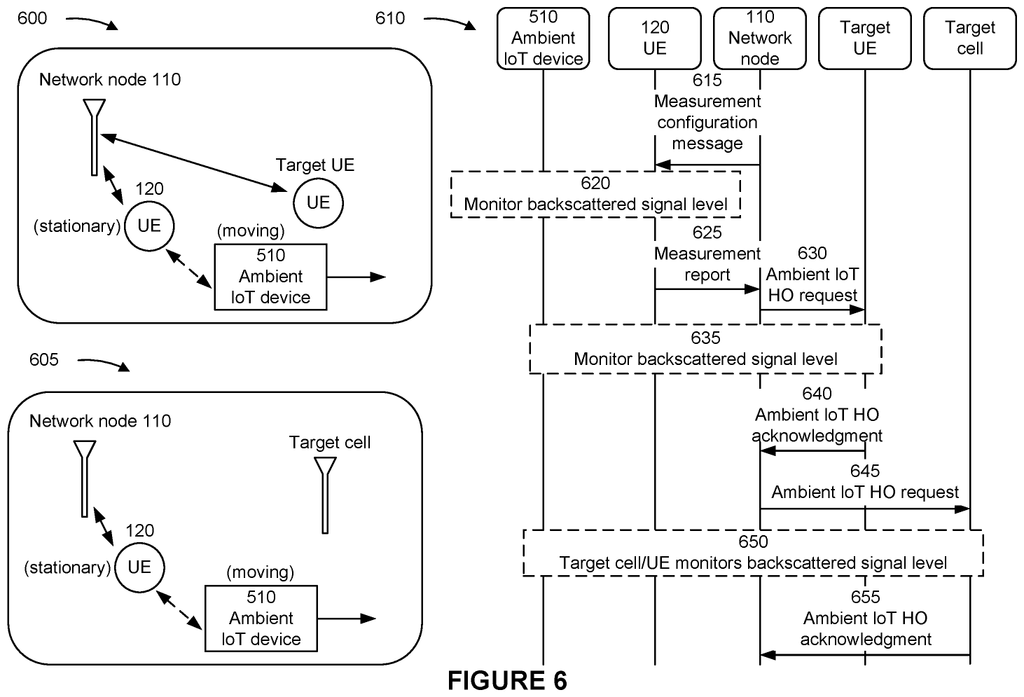

FIG. 6 is a diagram illustrating an example of a first scenario associated with ambient IoT device handover.

In the first scenario, the UE 120 may be a stationary device and the ambient IoT device 510 may be a mobile device. The network node 110 may be a source serving cell for the UE 120 and/or the ambient IoT device 510. In example 600, the ambient IoT device 510 may move away from the UE 120 and toward a target UE served by the network node 110. In example 605, the ambient IoT device 510 may move away from the UE 120 and toward a target cell. The target UE and the target cell may be examples of the target entity 520.

In example 610, the ambient IoT device 510, the UE 120, the network node 110, the target UE, and/or the target cell may communicate with each other and effectuate a handover of the ambient IoT device 510. In a first operation 615, the network node 110 may transmit, and the UE 120 may receive, a measurement configuration message associated with the ambient IoT device 510. For example, the network node 110 may transmit, and the UE 120 may receive, signaling that contains the measurement configuration message. The measurement configuration message may be associated with the ambient IoT device 510 in that the measurement configuration message may configure the UE 120 to monitor a backscattered signal level of a backscattered signal received from the ambient IoT device 510. In some examples, the measurement configuration message may be specific to the ambient IoT device 510. In some examples, the measurement configuration message may be referred to as an ambient IoT measurement configuration message.

In some aspects, the measurement configuration message may indicate a backscattered signal level threshold. For example, the measurement configuration message may specify a threshold of a backscattered signal level of a backscattered signal received from the ambient IoT device 510. In some aspects, the measurement configuration message may indicate (for example, report) a time period associated with the backscattered signal level. The time period may be associated with the backscattered signal level in that the UE 120 may be configured to monitor the backscattered signal level for at least the time period.

In a second operation 620, the UE 120 may monitor the backscattered signal level of the backscattered signal received from the ambient IoT device 510. For example, the UE 120 may receive the backscattered signal and measure the backscattered signal level of the backscattered signal.

In a third operation 625, the UE 120 may transmit, and the network node 110 may receive, a measurement report associated with the ambient IoT device 510. For example, the UE 120 may transmit the measurement report while, or in response to, monitoring the backscattered signal level. In some aspects, the measurement report may indicate the backscattered signal level of the backscattered signal. For example, the measurement report may indicate the backscattered signal level as one or more RSRP values in units of dBm. In some aspects, the UE 120 may initiate the handover of the ambient IoT device 510 responsive to the backscattered signal level of the backscattered signal not satisfying a backscattered signal level threshold. For example, the UE 120 may transmit the measurement report responsive to the backscattered signal level not satisfying (for example, being below) the backscattered signal level threshold. For example, the UE 120 may transmit the measurement report responsive to the backscattered signal level not satisfying the backscattered signal level threshold for the time period. Thus, if the backscattered signal level is less than the backscattered signal level threshold within the time period, then the UE 120 may transmit the measurement report (for example, the UE 120 may wait for the time period to expire before responding to the measurement configuration message with the measurement report). In some examples, the measurement report may be referred to as an ambient IoT measurement report.

In a fourth operation 630, the network node 110 may transmit, in accordance with the measurement report, an ambient IoT device handover request to the target UE. In some examples, the network node 110 may transmit the ambient IoT handover request to one or more connected UEs (for example, UEs connected to the network node 110), including the target UE. The ambient IoT device handover request may be referred to as an ambient IoT handover request.

In some aspects, transmitting the measurement report may configure the network node 110 to transmit the ambient IoT device handover request. For example, the measurement report indicating that the backscattered signal level does not satisfy the backscattered signal level threshold may configure the network node 110 to transmit the ambient IoT device handover request.

In some aspects, the ambient IoT device handover request may include an indication of one or more capabilities of the ambient IoT device 510 or a measurement configuration (for example, an ambient IoT device measurement configuration message) associated with the ambient IoT device 510. For example, the ambient IoT device handover request may include an ambient-IoT-device specific configuration (for example, an identifier of the ambient IoT device 510 or an exciting signal for the ambient IoT device 510, among other examples).

In some aspects, the ambient IoT device handover request may include an indication of one or more (for example, a set of) topologies supported by the ambient IoT device 510. For example, the ambient IoT device handover request may indicate whether the ambient IoT device 510 support topology 1, topology 2, topology 3, and/or topology 4.

Operations 635 and 640 relate to a scenario shown by example 600 (for example, where the ambient IoT device 510 moves toward the target UE). In a fifth operation 635, the target UE may monitor a backscattered signal level of a backscattered signal, associated with the ambient IoT device 510, that is received by the target UE. The backscattered signal received by the target UE may be associated with the ambient IoT device 510 in that the backscattered signal may be backscattered by the ambient IoT device 510. The target UE may monitor the backscattered signal level using the identifier of the ambient IoT device 510 or an exciting signal for the ambient IoT device 510, among other examples.

In a sixth operation 640, in some aspects, the network node 110 may receive, from the target UE, an ambient IoT device handover acknowledgment associated with the ambient IoT device handover request. The ambient IoT device handover acknowledgment may be associated with the ambient IoT device handover request in that the target UE may transmit the ambient IoT device handover acknowledgment in response to the ambient IoT device handover request. Additionally or alternatively, the ambient IoT device handover acknowledgment may be associated with the ambient IoT device handover request in that the target UE may transmit the ambient IoT device handover acknowledgment in response to detecting the backscattered signal that is received by the target UE. The ambient IoT device handover acknowledgment may be referred to as an ambient IoT handover acknowledgment.

In some aspects, the ambient IoT device handover acknowledgment may include an indication of the backscattered signal level of the backscattered signal that is received by the target UE, and the network node 110 may select the target UE in accordance with the backscattered signal level. For example, multiple connected UEs may respond to the network node 110 with respective ambient IoT device handover acknowledgments, and the network node 110 may select the connected UE that reports the highest backscattered signal level as the target UE.

After the target UE responds to the network node 110 with the ambient IoT device handover acknowledgment, the network node 110 may perform (for example, execute) handover of the ambient IoT device 510 to the target UE.

Operations 645, 650, and 655 relate to a scenario shown by example 605 (for example, where the ambient IoT device 510 moves toward the target cell). In a seventh operation 645, the network node 110 may transmit, in accordance with the measurement report, an ambient IoT device handover request to the target cell. In some examples, the network node 110 may transmit the ambient IoT handover request to one or more neighbor cells (for example, cells that neighbor the network node 110), including the target cell. In some examples, the network node 110 may transmit the measurement report to the target cell in response to not receiving any measurement reports from any connected UEs. In some examples, the network node 110 may transmit the measurement report to the target cell in response to not receiving, from any connected UEs, any measurement reports that indicate a backscattering signal level that satisfy the backscattering signal level threshold or another backscattering signal level threshold.

The ambient IoT device handover request transmitted to the target cell may include similar information as that included in the ambient IoT device handover request transmitted to the target UE. In some aspects, the ambient IoT device handover request may include the ambient-IoT-device-specific configuration. In some aspects, the ambient IoT device handover request may include an indication of one or more topologies supported by the ambient IoT device. For example, the ambient IoT device handover request may indicate whether the ambient IoT device 510 support topology 1, topology 2, topology 3, and/or topology 4.

In some aspects, the target cell may use the indication of the one or more topologies supported by the ambient IoT device 510 to forward the ambient IoT device handover request to one or more candidate target UEs (for example, UEs in the target cell). For example, if the ambient IoT device 510 supports a topology that enables the ambient IoT device 510 to connect to a UE that is connected to the target cell, then the target cell may forward the ambient IoT device handover request to the candidate target UEs. Depending on the configured topology, the ambient IoT device 510 may directly connect to the target cell or to a candidate target UE.

In an eighth operation 650, the target cell, and/or the candidate target UEs, may monitor a backscattered signal level of a backscattered signal, associated with the ambient IoT device 510, that is received by the target cell and/or the candidate target UEs. The backscattered signal received by the target cell and/or the candidate target UEs connected to the target cell may be associated with the ambient IoT device 510 in that the backscattered signal may be backscattered by the ambient IoT device 510. The target cell and/or the candidate target UEs connected to the target cell may monitor the backscattered signal level using the identifier of the ambient IoT device 510 or an exciting signal for the ambient IoT device 510, among other examples.

In a ninth operation 655, the network node 110 may receive, from the target cell, an ambient IoT device handover acknowledgment associated with the ambient IoT device handover request. For example, the target cell may respond to the ambient IoT device handover request with the ambient IoT device handover acknowledgment.

After the target cell responds to the network node 110 with the ambient IoT device handover acknowledgment, the network node 110 may perform (for example, execute) handover of the ambient IoT device 510 to the target cell.

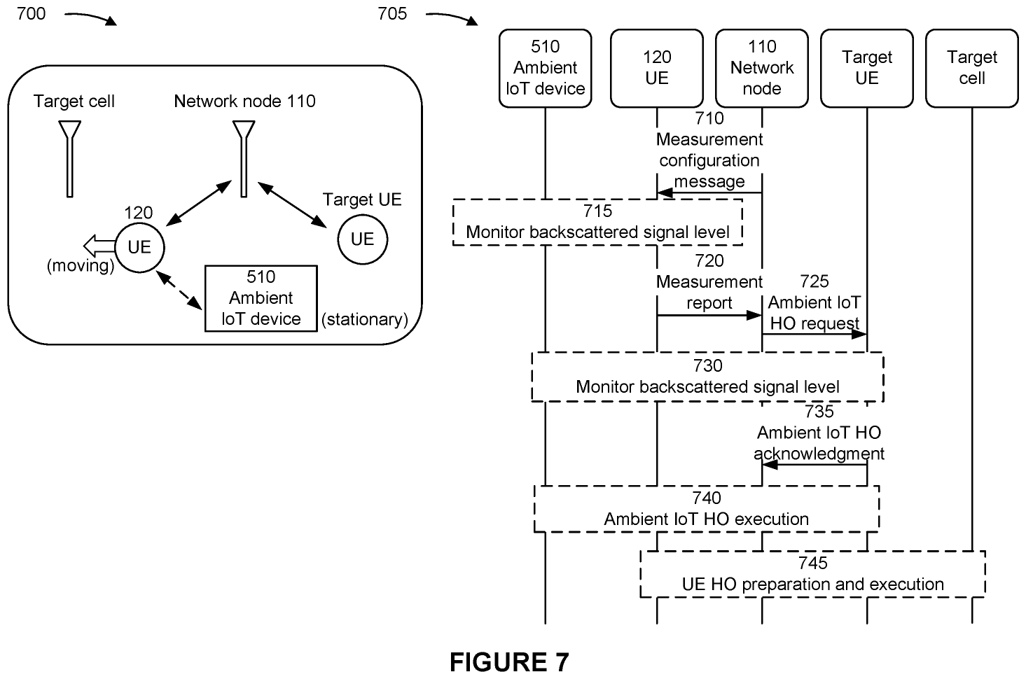

FIG. 7 is a diagram illustrating an example of a second scenario associated with ambient IoT device handover.

In the second scenario, the UE 120 may be a mobile device and the ambient IoT device 510 may be a stationary device. In example 700, IoT device 510 may be a mobile device. The network node 110 may be a source serving cell for the UE 120, the ambient IoT device 510, and/or the target UE. In example 700, the UE 120 may move away from the ambient IoT device 510 and toward a target cell. The target UE may be an example of the target entity 520.

In example 705, the ambient IoT device 510, the UE 120, the network node 110, the target UE, and/or the target cell may communicate with each other and effectuate a handover of the ambient IoT device 510. In a first operation 710, the network node 110 may transmit, and the UE 120 may receive, a measurement configuration message associated with the ambient IoT device 510. For example, the network node 110 may transmit, and the UE 120 may receive, signaling that contains the measurement configuration message. The measurement configuration message may be associated with the ambient IoT device 510 in that the measurement configuration message may configure the UE 120 to monitor a backscattered signal level of a backscattered signal received from the ambient IoT device 510. In some examples, the measurement configuration message may be specific to the ambient IoT device 510. In some examples, the measurement configuration message may be referred to as an ambient IoT measurement configuration message.

In some aspects, the measurement configuration message may indicate a backscattered signal level threshold. For example, the measurement configuration message may specify a threshold of a backscattered signal level of a backscattered signal received from the ambient IoT device 510. In some aspects, the measurement configuration message may indicate (for example, report) a time period associated with the backscattered signal level. The time period may be associated with the backscattered signal level in that the UE 120 may be configured to monitor the backscattered signal level for at least the time period.

In a second operation 715, the UE 120 may monitor the backscattered signal level of the backscattered signal received from the ambient IoT device 510. For example, the UE 120 may receive the backscattered signal and measure the backscattered signal level of the backscattered signal.

In a third operation 720, the UE 120 may transmit, and the network node 110 may receive, a measurement report associated with the ambient IoT device 510. For example, the UE 120 may transmit the measurement report while, or in response to, monitoring the backscattered signal level. In some aspects, the measurement report may indicate the backscattered signal level of the backscattered signal. For example, the measurement report may indicate the backscattered signal level as one or more RSRP values in units of dBm. In some aspects, the UE 120 may initiate the handover of the ambient IoT device 510 responsive to the backscattered signal level of the backscattered signal not satisfying a backscattered signal level threshold. For example, the UE 120 may transmit the measurement report responsive to the backscattered signal level not satisfying (for example, being below) the backscattered signal level threshold. For example, the UE 120 may transmit the measurement report responsive to the backscattered signal level not satisfying the backscattered signal level threshold for the time period. Thus, if the backscattered signal level is less than the backscattered signal level threshold within the time period, then the UE 120 may transmit the measurement report (for example, the UE 120 may wait for the time period to expire before responding to the measurement configuration message with the measurement report). In some examples, the measurement report may be referred to as an ambient IoT measurement report.

In a fourth operation 725, the network node 110 may transmit, in accordance with the measurement report, an ambient IoT device handover request to the target UE. In some examples, the network node 110 may transmit the ambient IoT handover request to one or more connected UEs (for example, UEs connected to the network node 110), including the target UE. The ambient IoT device handover request may be referred to as an ambient IoT handover request.

In some aspects, transmitting the measurement report may configure the network node 110 to transmit the ambient IoT device handover request. For example, the measurement report indicating that the backscattered signal level does not satisfy the backscattered signal level threshold may configure the network node 110 to transmit the ambient IoT device handover request.

In some aspects, the ambient IoT device handover request may include an indication of one or more capabilities of the ambient IoT device 510 or a measurement configuration (for example, an ambient IoT device measurement configuration message) associated with the ambient IoT device 510. For example, the ambient IoT device handover request may include an ambient-IoT-device specific configuration (for example, an identifier of the ambient IoT device 510 or an exciting signal for the ambient IoT device 510, among other examples).

In some aspects, the ambient IoT device handover request may include an indication of one or more (for example, a set of) topologies supported by the ambient IoT device 510. For example, the ambient IoT device handover request may indicate whether the ambient IoT device 510 support topology 1, topology 2, topology 3, and/or topology 4.

In a fifth operation 730, the target UE may monitor a backscattered signal level of a backscattered signal, associated with the ambient IoT device 510, that is received by the target UE. The backscattered signal received by the target UE may be associated with the ambient IoT device 510 in that the backscattered signal may be backscattered by the ambient IoT device 510. The target UE may monitor the backscattered signal level using the identifier of the ambient IoT device 510 or an exciting signal for the ambient IoT device 510, among other examples.

In a sixth operation 735, in some aspects, the network node 110 may receive, from the target UE, an ambient IoT device handover acknowledgment associated with the ambient IoT device handover request. The ambient IoT device handover acknowledgment may be associated with the ambient IoT device handover request in that the target UE may transmit the ambient IoT device handover acknowledgment in response to the ambient IoT device handover request. Additionally or alternatively, the ambient IoT device handover acknowledgment may be associated with the ambient IoT device handover request in that the target UE may transmit the ambient IoT device handover acknowledgment in response to detecting the backscattered signal that is received by the target UE. The ambient IoT device handover acknowledgment may be referred to as an ambient IoT handover acknowledgment.

In some aspects, the ambient IoT device handover acknowledgment may include an indication of the backscattered signal level of the backscattered signal that is received by the target UE, and the network node 110 may select the target UE in accordance with the backscattered signal level. For example, multiple connected UEs may respond to the network node 110 with respective ambient IoT device handover acknowledgments, and the network node 110 may select the connected UE that reports the highest backscattered signal level as the target UE.

In a seventh operation 740, the network node 110 may perform (for example, execute) handover of the ambient IoT device 510 to the target UE. In an eighth operation 745, the network node 110 may perform (for example, execute) handover of the UE 120 to the target cell.

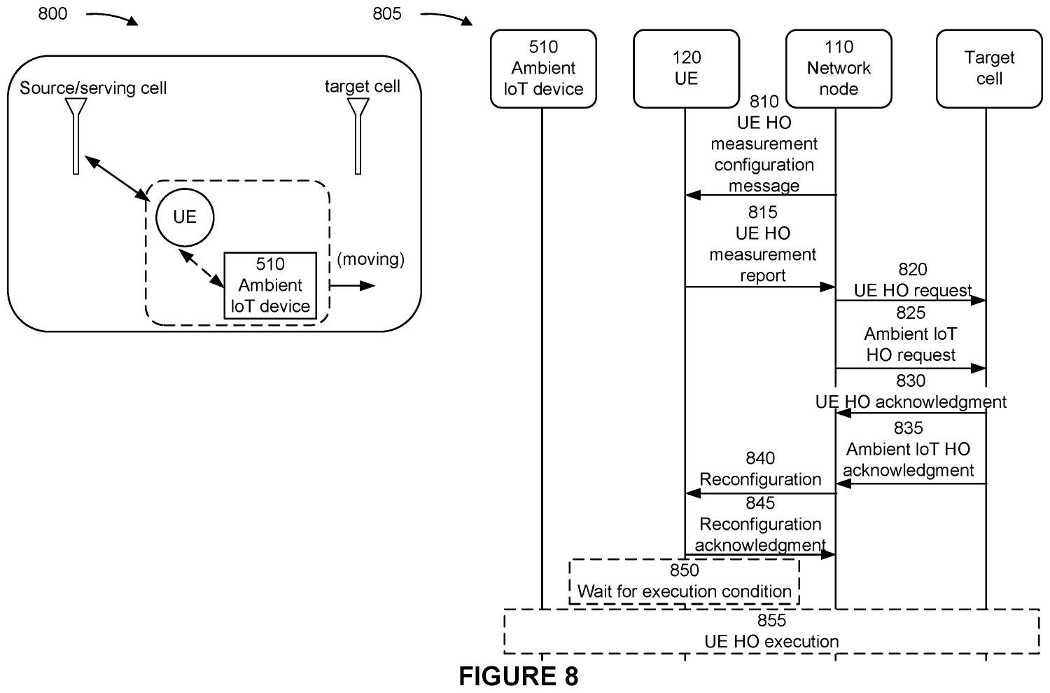

FIG. 8 is a diagram illustrating an example of a third scenario associated with ambient IoT device handover.

In the third scenario, the UE 120 may be a mobile device and the ambient IoT device 510 may be a mobile device. The network node 110 may be a source cell or serving cell for the UE 120 and/or the ambient IoT device 510. In example 800, in some scenarios, the ambient IoT device 510 may move out of the serving cell in the company of the UE 120. For example, the ambient IoT device 510 and the UE 120 may together (for example, jointly) move away from the network node 110 and toward a target cell. The target cell may be an example of the target entity 520.

In some examples, the UE 120 may receive a backscattered signal from the ambient IoT device 510 (for example, as part of transferring ambient IoT data and/or signaling between the network node 110 and the ambient IoT device). Because a distance between the ambient IoT device 510 and the UE 120 may be fixed, the backscattered signal level of the backscattered may also be fixed.

In example 805, the ambient IoT device 510, the UE 120, the network node 110, the target UE, and/or the target cell may communicate with each other and effectuate a handover of the ambient IoT device 510. In a first operation 810, the network node 110 may transmit, and the UE 120 may receive, a UE handover measurement configuration message. The UE handover measurement configuration message may be used to identify potential target cells for the (joint) UE 120 and ambient IoT device 510.

In a second operation 815, the UE 120 may transmit, and the network node 110 may receive, a measurement report (for example, a UE handover measurement report). For example, the UE 120 may respond to the UE handover measurement configuration message with the UE handover measurement report. The UE handover measurement report may indicate that a potential target cell is the target cell.

In a third operation 820, the network node 110 may transmit, in accordance with the UE handover measurement report, a UE handover request to the target cell. In a fourth operation 825, the network node 110 may transmit, in accordance with the UE handover measurement report, an ambient IoT device handover request to the target cell. Thus, the network node 110 may transmit two handover requests to the target cell: a handover request for the UE (for example, the UE handover request) and a handover request for the ambient IoT device 510 (for example, the ambient IoT device handover request). The ambient IoT device handover request may be referred to as an ambient IoT handover request.

In some aspects, transmitting the UE handover measurement report may configure the network node 110 to transmit the ambient IoT device handover request. For example, the measurement report indicating that the backscattered signal level does not satisfy the backscattered signal level threshold may configure the network node 110 to transmit the ambient IoT device handover request.

In some aspects, the ambient IoT device handover request may include an indication of one or more capabilities of the ambient IoT device 510 or a resource configuration associated with the ambient IoT device 510. For example, the ambient IoT device handover request may convey a current resource configuration of the ambient IoT device 510.

In a fifth operation 830, the network node 110 may receive, from the target UE, a UE handover acknowledgment. For example, the UE handover acknowledgment may acknowledge the UE handover request. In a sixth operation 835, the network node 110 may receive, from the target UE, an ambient IoT device handover acknowledgment, associated with the ambient IoT device handover request, that indicates whether the resource configuration is available. For example, the ambient IoT device handover acknowledgment may indicate whether the same resource configuration of the ambient IoT device 510 that is available at the network node 110 (for example, current resource configuration of the ambient IoT device 510) is also available at the target cell. The ambient IoT device handover acknowledgment may be associated with the ambient IoT device handover request in that the target UE may transmit the ambient IoT device handover acknowledgment in response to the ambient IoT device handover request. The ambient IoT device handover acknowledgment may be referred to as an ambient IoT handover acknowledgment.

In some aspects, the ambient IoT device handover acknowledgment may indicate that the resource configuration is unavailable, and network node 110 may receive, from the target cell, another resource configuration associated with the ambient IoT device 510. For example, the ambient IoT device handover acknowledgment may indicate that the current resource configuration of the ambient IoT device 510 is unavailable at the target cell. The other resource configuration may be associated with the ambient IoT device 510 in that the other resource configuration may be available for the ambient IoT device 510 at the target cell.

In a seventh operation 840, the network node 110 may transmit, and the UE 120 may receive, a reconfiguration. In an eighth operation 845, the UE 120 may transmit, and the network node 110 may receive, an acknowledgment of the reconfiguration. In a ninth operation 850, the UE 120 may wait for an execution condition. In a tenth operation 855, the UE 120 may perform (for example, execute) handover to the target cell. For example, the UE 120 may perform the handover in response to identifying that the execution condition occurred.

Initiating the handover of the ambient IoT device 510 and/or transmitting the ambient IoT device handover request may enable handover of the ambient IoT device 510, which may help to ensure that the ambient IoT device 510 maintains network connectivity. For example, the ambient IoT device 510 may maintain network connectivity under various scenarios of topology 2 in which the ambient IoT device 510 and/or the UE 120 are mobile. In some examples, the ambient IoT device 510 may maintain network connectivity in scenarios where the UE 120 is a stationary device and the ambient IoT device 510 is a mobile device. In some examples, the ambient IoT device 510 may maintain network connectivity in scenarios where the UE 120 is a mobile device and the ambient IoT device 510 is a stationary device. In some examples, the ambient IoT device 510 may maintain network connectivity in scenarios where the UE 120 is a mobile device and the ambient IoT device 510 is a mobile device.

The measurement configuration message indicating the backscattered signal level threshold may enable the UE 120 to transmit the measurement report in response to the backscattered signal level not satisfying the backscattered signal level threshold, which may further conserve overhead. For example, the UE 120 may refrain from transmitting the measurement report if the backscattered signal level satisfies (for example, is greater than) the backscattered signal level threshold.

The measurement configuration message indicating the time period associated with the backscattered signal level may help to ensure that the UE 120 collects a sufficient sample size when monitoring the backscattered signal level before transmitting the measurement report, which may further conserve overhead and/or improve network connectivity of the ambient IoT device 510. For example, the UE 120 may refrain from transmitting the measurement report if the backscattered signal level temporarily dips below the backscattered signal level threshold.

Transmitting the ambient IoT device handover request to the target UE may further conserve overhead by enabling the network node 110 to avoid establishing a different configuration for the ambient IoT device 510 on a target cell. Transmitting the ambient IoT device handover request to the target cell may enable the ambient IoT device 510 to maintain network connectivity if no target UEs are available in a serving cell of the network node 110 to serve the ambient IoT device 510.

The ambient IoT device handover acknowledgment indicating whether the resource configuration is available may enable the target cell to re-use the same resource configuration, which may further conserve overhead.

Transmitting the request for the other UE to serve the ambient IoT device 510 may improve robustness of network services by enabling the network node 110 to associate a minimum quantity of serving UEs with the ambient IoT device 510.

FIG. 9 is a flowchart illustrating an example process 900 performed, for example, at a UE or an apparatus of a UE that supports ambient IoT device handover. Example process 900 is an example where the apparatus or the UE (for example, UE 120) performs operations associated with ambient IoT device handover.

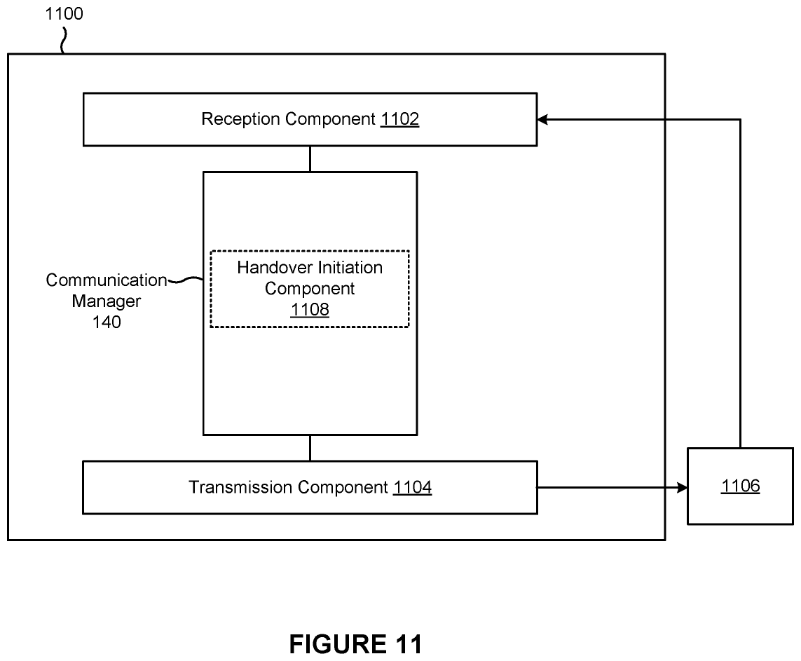

As shown in FIG. 9, in some aspects, process 900 may include receiving a backscattered signal associated with an ambient IoT device, wherein the UE is configured to transfer information between the ambient IoT device and a network node (block 910). For example, the UE (such as by using communication manager 140 or reception component 1102, depicted in FIG. 11) may receive a backscattered signal associated with an ambient IoT device, wherein the UE is configured to transfer information between the ambient IoT device and a network node, as described above.

As further shown in FIG. 9, in some aspects, process 900 may include initiating a handover of the ambient IoT device (block 920). For example, the UE (such as by using communication manager 140 or handover initiation component 1108, depicted in FIG. 11) may initiate a handover of the ambient IoT device, as described above.

Process 900 may include additional aspects, such as any single aspect or any combination of aspects described below or in connection with one or more other processes described elsewhere herein.

In a first additional aspect, process 900 includes receiving a measurement configuration message, associated with the ambient IoT device, that indicates a backscattered signal level threshold.

In a second additional aspect, alone or in combination with the first aspect, process 900 includes transmitting a measurement report, associated with the ambient IoT device, that indicates a backscattered signal level of the backscattered signal.

In a third additional aspect, alone or in combination with one or more of the first and second aspects, process 900 includes receiving a measurement configuration message, associated with the ambient IoT device, that indicates a time period associated with the backscattered signal level.

In a fourth additional aspect, alone or in combination with one or more of the first through third aspects, initiating the handover of the ambient IoT device includes transmitting a measurement report that configures the network node to transmit an ambient IoT device handover request.

In a fifth additional aspect, alone or in combination with one or more of the first through fourth aspects, the UE is a stationary device and the ambient IoT device is a mobile device.

In a sixth additional aspect, alone or in combination with one or more of the first through fifth aspects, the UE is a mobile device and the ambient IoT device is a stationary device or a mobile device.

In a seventh additional aspect, alone or in combination with one or more of the first through sixth aspects, the UE is the mobile device and the ambient IoT device is the stationary device, and initiating the handover of the ambient IoT device includes initiating the handover of the ambient IoT device responsive to a backscattered signal level of the backscattered signal not satisfying a backscattered signal level threshold.

In an eighth additional aspect, alone or in combination with one or more of the first through seventh aspects, the handover of the ambient IoT device is from the network node to a target UE or a target cell.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a flowchart illustrating an example process 1000 performed, for example, at a network node or an apparatus of a network node that supports ambient IoT device handover. Example process 1000 is an example where the apparatus or the network node (for example, network node 110) performs operations associated with ambient IoT device handover.

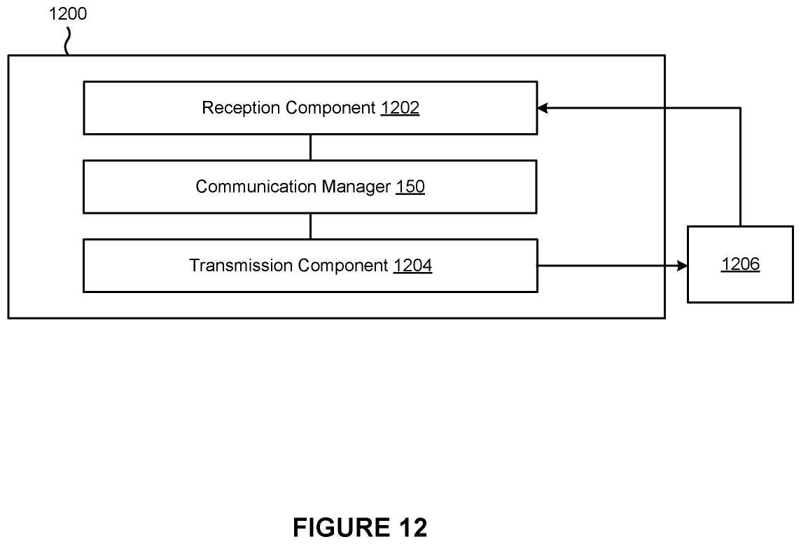

As shown in FIG. 10, in some aspects, process 1000 may include receiving a measurement report from a UE configured to transfer information between an ambient IoT device and the network node (block 1010). For example, the network node (such as by using communication manager 150 or reception component 1202, depicted in FIG. 12) may receive a measurement report from a UE configured to transfer information between an ambient IoT device and the network node, as described above.

As further shown in FIG. 10, in some aspects, process 1000 may include transmitting, in accordance with the measurement report, an ambient IoT device handover request (block 1020). For example, the network node (such as by using communication manager 150 or transmission component 1204, depicted in FIG. 12) may transmit, in accordance with the measurement report, an ambient IoT device handover request, as described above.

Process 1000 may include additional aspects, such as any single aspect or any combination of aspects described below or in connection with one or more other processes described elsewhere herein.

In a first additional aspect, the ambient IoT device handover request includes an indication of one or more capabilities of the ambient IoT device or a measurement configuration associated with the ambient IoT device.

In a second additional aspect, alone or in combination with the first aspect, the ambient IoT device handover request includes an indication of one or more topologies supported by the ambient IoT device.

In a third additional aspect, alone or in combination with one or more of the first and second aspects, transmitting the ambient IoT device handover request includes transmitting the ambient IoT device handover request to a target UE.

In a fourth additional aspect, alone or in combination with one or more of the first through third aspects, process 1000 includes receiving, from the target UE, an ambient IoT device handover acknowledgment associated with the ambient IoT device handover request.

In a fifth additional aspect, alone or in combination with one or more of the first through fourth aspects, the ambient IoT device handover acknowledgment includes an indication of a backscattered signal level of a backscattered signal, associated with the ambient IoT device, that is received by the target UE, and process 900 includes selecting the target UE in accordance with the backscattered signal level.

In a sixth additional aspect, alone or in combination with one or more of the first through fifth aspects, transmitting the ambient IoT device handover request includes transmitting the ambient IoT device handover request to a target cell.

In a seventh additional aspect, alone or in combination with one or more of the first through sixth aspects, process 1000 includes receiving, from the target cell, an ambient IoT device handover acknowledgment associated with the ambient IoT device handover request.

In an eighth additional aspect, alone or in combination with one or more of the first through seventh aspects, the ambient IoT device handover request includes an indication, of one or more topologies supported by the ambient IoT device, that is used by the target cell to forward the ambient IoT device handover request to one or more candidate target UEs.

In a ninth additional aspect, alone or in combination with one or more of the first through eighth aspects, the ambient IoT device handover request includes an indication of one or more capabilities of the ambient IoT device or a resource configuration associated with the ambient IoT device.

In a tenth additional aspect, alone or in combination with one or more of the first through ninth aspects, process 1000 includes receiving, from the target cell, an ambient IoT device handover acknowledgment, associated with the ambient IoT device handover request, that indicates whether the resource configuration is available.

In an eleventh additional aspect, alone or in combination with one or more of the first through tenth aspects, the ambient IoT device handover acknowledgment indicates that the resource configuration is unavailable, and process 1000 includes receiving, from the target cell, another resource configuration associated with the ambient IoT device.

In a twelfth additional aspect, alone or in combination with one or more of the first through eleventh aspects, a plurality of UEs, including the UE, are configured to serve the ambient IoT device, and process 1000 includes receiving, from the plurality of UEs, a plurality of measurement reports, and transmitting, in association with the plurality of measurement reports and a quantity of the plurality of UEs, a request for another UE to serve the ambient IoT device.

In a thirteenth additional aspect, alone or in combination with one or more of the first through twelfth aspects, process 1000 includes receiving a configuration of a UE minimum quantity threshold, and transmitting the request for the other UE to serve the ambient IoT device includes transmitting the request for the other UE to serve the ambient IoT device responsive to the quantity of the plurality of UEs not satisfying the UE minimum quantity threshold.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a diagram of an example apparatus 1100 for wireless communication that supports ambient IoT device handover. The apparatus 1100 may be a UE, or a UE may include the apparatus 1100. In some aspects, the apparatus 1100 includes a reception component 1102, a transmission component 1104, and a communication manager 140, which may be in communication with one another (for example, via one or more buses). As shown, the apparatus 1100 may communicate with another apparatus 1106 (such as a UE, a network node, or another wireless communication device) using the reception component 1102 and the transmission component 1104.

In some aspects, the apparatus 1100 may be configured to and/or operable to perform one or more operations described herein in connection with FIGS. 5-8. Additionally or alternatively, the apparatus 1100 may be configured to and/or operable to perform one or more processes described herein, such as process 900 of FIG. 9. In some aspects, the apparatus 1100 may include one or more components of the UE described above in connection with FIG. 2.

The reception component 1102 may receive communications, such as reference signals, control information, and/or data communications, from the apparatus 1106. The reception component 1102 may provide received communications to one or more other components of the apparatus 1100, such as the communication manager 140. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1102 may include one or more antennas, one or more modems, one or more demodulators, one or more MIMO detectors, one or more receive processors, one or more controllers/processors, and/or one or more memories of the UE described above in connection with FIG. 2.

The transmission component 1104 may transmit communications, such as reference signals, control information, and/or data communications, to the apparatus 1106. In some aspects, the communication manager 140 may generate communications and may transmit the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 1104 may be co-located with the reception component 1102 in one or more transceivers.

The communication manager 140 may receive or may cause the reception component 1102 to receive a backscattered signal associated with an ambient IoT device, wherein the UE is configured to transfer information between the ambient IoT device and a network node. The communication manager 140 may initiate a handover of the ambient IoT device. In some aspects, the communication manager 140 may perform one or more operations described elsewhere herein as being performed by one or more components of the communication manager 140.

The communication manager 140 may include one or more controllers/processors and/or one or more memories of the UE described above in connection with FIG. 2. In some aspects, the communication manager 140 includes a set of components, such as a handover initiation component 1108. Alternatively, the set of components may be separate and distinct from the communication manager 140. In some aspects, one or more components of the set of components may include or may be implemented within one or more controllers/processors and/or one or more memories of the UE described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive a backscattered signal associated with an ambient IoT device, wherein the UE is configured to transfer information between the ambient IoT device and a network node. The handover initiation component 1108 may initiate a handover of the ambient IoT device.

The reception component 1102 may receive a measurement configuration message, associated with the ambient IoT device, that indicates a backscattered signal level threshold.

The transmission component 1104 may transmit a measurement report, associated with the ambient IoT device, that indicates a backscattered signal level of the backscattered signal.

The reception component 1102 may receive a measurement configuration message, associated with the ambient IoT device, that indicates a time period associated with the backscattered signal level.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

FIG. 12 is a diagram of an example apparatus 1200 for wireless communication that supports ambient IoT device handover. The apparatus 1200 may be a network node, or a network node may include the apparatus 1200. In some aspects, the apparatus 1200 includes a reception component 1202, a transmission component 1204, and a communication manager 150, which may be in communication with one another (for example, via one or more buses). As shown, the apparatus 1200 may communicate with another apparatus 1206 (such as a UE, a network node, or another wireless communication device) using the reception component 1202 and the transmission component 1204.

In some aspects, the apparatus 1200 may be configured to and/or operable to perform one or more operations described herein in connection with FIGS. 5-8. Additionally or alternatively, the apparatus 1200 may be configured to and/or operable to perform one or more processes described herein, such as process 1000 of FIG. 10. In some aspects, the apparatus 1200 may include one or more components of the network node described above in connection with FIG. 2.

The reception component 1202 may receive communications, such as reference signals, control information, and/or data communications, from the apparatus 1206. The reception component 1202 may provide received communications to one or more other components of the apparatus 1200, such as the communication manager 150. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, one or more modems, one or more demodulators, one or more MIMO detectors, one or more receive processors, one or more controllers/processors, and/or one or more memories of the network node described above in connection with FIG. 2.

The transmission component 1204 may transmit communications, such as reference signals, control information, and/or data communications, to the apparatus 1206. In some aspects, the communication manager 150 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 1204 may be co-located with the reception component 1202 in one or more transceivers.

The communication manager 150 may receive or may cause the reception component 1202 to receive a measurement report from a UE configured to transfer information between an ambient IoT device and the network node. The communication manager 150 may transmit or may cause the transmission component 1204 to transmit, in accordance with the measurement report, an ambient IoT device handover request. In some aspects, the communication manager 150 may perform one or more operations described elsewhere herein as being performed by one or more components of the communication manager 150. The communication manager 150 may include one or more controllers/processors, one or more memories, one or more schedulers, and/or one or more communication units of the network node described above in connection with FIG. 2.

The reception component 1202 may receive a measurement report from a UE configured to transfer information between an ambient IoT device and the network node. The transmission component 1204 may transmit, in accordance with the measurement report, an ambient IoT device handover request.

The reception component 1202 may receive, from the target UE, an ambient IoT device handover acknowledgment associated with the ambient IoT device handover request.

The reception component 1202 may receive, from the target cell, an ambient IoT device handover acknowledgment associated with the ambient IoT device handover request.

The reception component 1202 may receive, from the target cell, an ambient IoT device handover acknowledgment, associated with the ambient IoT device handover request, that indicates whether the resource configuration is available.

The reception component 1202 may receive a configuration of a UE minimum quantity threshold, wherein transmitting the request for the other UE to serve the ambient IoT device includes transmitting the request for the other UE to serve the ambient IoT device responsive to the quantity of the plurality of UEs not satisfying the UE minimum quantity threshold.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed at a UE, comprising: receiving a backscattered signal associated with an ambient IoT device, wherein the UE is configured to transfer information between the ambient IoT device and a network node; and initiating a handover of the ambient IoT device.
Aspect 2: The method of Aspect 1, further comprising: receiving a measurement configuration message, associated with the ambient IoT device, that indicates a backscattered signal level threshold.
Aspect 3: The method of any of Aspects 1-2, further comprising: transmitting a measurement report, associated with the ambient IoT device, that indicates a backscattered signal level of the backscattered signal.
Aspect 4: The method of Aspect 3, further comprising: receiving a measurement configuration message, associated with the ambient IoT device, that indicates a time period associated with the backscattered signal level.
Aspect 5: The method of any of Aspects 1-4, wherein initiating the handover of the ambient IoT device includes transmitting a measurement report that configures the network node to transmit an ambient IoT device handover request.
Aspect 6: The method of any of Aspects 1-5, wherein the UE is a stationary device and the ambient IoT device is a mobile device.
Aspect 7: The method of any of Aspects 1-6, wherein the UE is a mobile device and the ambient IoT device is a stationary device or a mobile device.
Aspect 8: The method of any of Aspects 1-7, wherein the UE is the mobile device and the ambient IoT device is the stationary device, and wherein initiating the handover of the ambient IoT device includes initiating the handover of the ambient IoT device responsive to a backscattered signal level of the backscattered signal not satisfying a backscattered signal level threshold.
Aspect 9: The method of any of Aspects 1-8, wherein the handover of the ambient IoT device is from the network node to a target UE or to a target cell.
Aspect 10: A method of wireless communication performed at a network node, comprising: receiving a measurement report from a UE configured to transfer information between an ambient IoT device and the network node; and transmitting, in accordance with the measurement report, an ambient IoT device handover request.
Aspect 11: The method of Aspect 10, wherein the ambient IoT device handover request includes an indication of one or more capabilities of the ambient IoT device or a measurement configuration associated with the ambient IoT device.
Aspect 12: The method of any of Aspects 10-11, wherein the ambient IoT device handover request includes an indication of one or more topologies supported by the ambient IoT device.
Aspect 13: The method of any of Aspects 10-12, wherein transmitting the ambient IoT device handover request includes transmitting the ambient IoT device handover request to a target UE.
Aspect 14: The method of Aspect 13, further comprising: receiving, from the target UE, an ambient IoT device handover acknowledgment associated with the ambient IoT device handover request.
Aspect 15: The method of Aspect 14, wherein the ambient IoT device handover acknowledgment includes an indication of a backscattered signal level of a backscattered signal, associated with the ambient IoT device, that is received by the target UE, the method further comprising: selecting the target UE in accordance with the backscattered signal level.
Aspect 16: The method of any of Aspects 10-15, wherein transmitting the ambient IoT device handover request includes transmitting the ambient IoT device handover request to a target cell.
Aspect 17: The method of Aspect 16, further comprising: receiving, from the target cell, an ambient IoT device handover acknowledgment associated with the ambient IoT device handover request.
Aspect 18: The method of Aspect 16, wherein the ambient IoT device handover request includes an indication, of one or more topologies supported by the ambient IoT device, that is used by the target cell to forward the ambient IoT device handover request to one or more candidate target UEs.
Aspect 19: The method of Aspect 16, wherein the ambient IoT device handover request includes an indication of one or more capabilities of the ambient IoT device or a resource configuration associated with the ambient IoT device.
Aspect 20: The method of Aspect 19, further comprising: receiving, from the target cell, an ambient IoT device handover acknowledgment, associated with the ambient IoT device handover request, that indicates whether the resource configuration is available.
Aspect 21: The method of Aspect 20, wherein the ambient IoT device handover acknowledgment indicates that the resource configuration is unavailable, the method further comprising: receiving, from the target cell, another resource configuration associated with the ambient IoT device.
Aspect 22: The method of any of Aspects 10-21, wherein a plurality of UEs, including the UE, are configured to serve the ambient IoT device, the method further comprising: receiving, from the plurality of UEs, a plurality of measurement reports; and transmitting, in association with the plurality of measurement reports and a quantity of the plurality of UEs, a request for another UE to serve the ambient IoT device.
Aspect 23: The method of Aspect 22, further comprising: receiving a configuration of a UE minimum quantity threshold, wherein transmitting the request for the other UE to serve the ambient IoT device includes transmitting the request for the other UE to serve the ambient IoT device responsive to the quantity of the plurality of UEs not satisfying the UE minimum quantity threshold.
Aspect 24: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-23.
Aspect 25: An apparatus for wireless communication at a device, the apparatus comprising one or more memories and one or more processors coupled to the one or more memories, the one or more processors configured to cause the device to perform the method of one or more of Aspects 1-23.
Aspect 26: An apparatus for wireless communication, the apparatus comprising at least one means for performing the method of one or more of Aspects 1-23.
Aspect 27: A non-transitory computer-readable medium storing code for wireless communication, the code comprising instructions executable by one or more processors to perform the method of one or more of Aspects 1-23.
Aspect 28: A non-transitory computer-readable medium storing a set of instructions for wireless communication, the set of instructions comprising one or more instructions that, when executed by one or more processors of a device, cause the device to perform the method of one or more of Aspects 1-23.
Aspect 29: A device for wireless communication, the device comprising a processing system that includes one or more processors and one or more memories coupled with the one or more processors, the processing system configured to cause the device to perform the method of one or more of Aspects 1-23.
Aspect 30: An apparatus for wireless communication at a device, the apparatus comprising one or more memories and one or more processors coupled to the one or more memories, the one or more processors individually or collectively configured to cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions. The term “identify” or “identifying” also encompasses a wide variety of actions and, therefore, “identifying” can include calculating, computing, processing, deriving, investigating, looking up (such as via looking up in a table, a database or another data structure), inferring, ascertaining, measuring, and the like. Also, “identifying” can include receiving (such as receiving information or receiving an indication), accessing (such as accessing data stored in memory), transmitting (such as transmitting information) and the like. Also, “identifying” can include resolving, selecting, obtaining, choosing, establishing and other such similar actions.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”).

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
receive a backscattered signal associated with an ambient internet of things (IoT) device, wherein the UE is configured to transfer information between the ambient IoT device and a network node; and
initiate a handover of the ambient IoT device.

2. The apparatus of claim 1, wherein at least one processor of the one or more processors is configured to cause the UE to:
receive a measurement configuration message, associated with the ambient IoT device, that indicates a backscattered signal level threshold.

3. The apparatus of claim 1, wherein at least one processor of the one or more processors is configured to cause the UE to:
transmit a measurement report, associated with the ambient IoT device, that indicates a backscattered signal level of the backscattered signal.

4. The apparatus of claim 3, wherein at least one processor of the one or more processors is configured to cause the UE to:
receive a measurement configuration message, associated with the ambient IoT device, that indicates a time period associated with the backscattered signal level.

5. The apparatus of claim 1, wherein the at least one processor, to cause the UE to initiate the handover of the ambient IoT device, is configured to cause the UE to transmit a measurement report that configures the network node to transmit an ambient IoT device handover request.

6. The apparatus of claim 1, wherein the UE is a stationary device and the ambient IoT device is a mobile device.

7. The apparatus of claim 1, wherein the UE is a mobile device and the ambient IoT device is a stationary device or a mobile device.

8. The apparatus of claim 7, wherein the UE is the mobile device and the ambient IoT device is the stationary device, and wherein the at least one processor, to cause the UE to initiate the handover of the ambient IoT device, is configured to cause the UE to initiate the handover of the ambient IoT device responsive to a backscattered signal level of the backscattered signal not satisfying a backscattered signal level threshold.

9. The apparatus of claim 1, wherein the handover of the ambient IoT device is from the network node to a target UE or a target cell.

10. An apparatus for wireless communication at a network node, comprising:
one or more memories storing processor-executable code; and
one or more processors coupled with the one or more memories, at least one processor of the one or more processors configured to cause the network node to:
receive a measurement report from a user equipment (UE) configured to transfer information between an ambient internet of things (IoT) device and the network node; and
transmit, in accordance with the measurement report, an ambient IoT device handover request.

11. The apparatus of claim 10, wherein the ambient IoT device handover request includes an indication of one or more capabilities of the ambient IoT device or a measurement configuration associated with the ambient IoT device.

12. The apparatus of claim 10, wherein the ambient IoT device handover request includes an indication of one or more topologies supported by the ambient IoT device.

13. The apparatus of claim 10, wherein the at least one processor, to cause the network node to transmit the ambient IoT device handover request, is configured to cause the network node to transmit the ambient IoT device handover request to a target UE.

14. The apparatus of claim 13, wherein at least one processor of the one or more processors is configured to cause the network node to:
receive, from the target UE, an ambient IoT device handover acknowledgment associated with the ambient IoT device handover request.

15. The apparatus of claim 14, wherein the ambient IoT device handover acknowledgment includes an indication of a backscattered signal level of a backscattered signal, associated with the ambient IoT device, that is received by the target UE, and wherein at least one processor of the one or more processors is configured to cause the network node to:
select the target UE in accordance with the backscattered signal level.

16. The apparatus of claim 10, wherein the at least one processor, to cause the network node to transmit the ambient IoT device handover request, is configured to cause the network node to transmit the ambient IoT device handover request to a target cell.

17. The apparatus of claim 16, wherein at least one processor of the one or more processors is configured to cause the network node to:
receive, from the target cell, an ambient IoT device handover acknowledgment associated with the ambient IoT device handover request.

18. The apparatus of claim 16, wherein the ambient IoT device handover request includes an indication, of one or more topologies supported by the ambient IoT device, that is used by the target cell to forward the ambient IoT device handover request to one or more candidate target UEs.

19. The apparatus of claim 16, wherein the ambient IoT device handover request includes an indication of one or more capabilities of the ambient IoT device or a resource configuration associated with the ambient IoT device.

20. The apparatus of claim 19, wherein at least one processor of the one or more processors is configured to cause the network node to:
receive, from the target cell, an ambient IoT device handover acknowledgment, associated with the ambient IoT device handover request, that indicates whether the resource configuration is available.

21. The apparatus of claim 20, wherein at least one processor of the one or more processors is configured to cause the network node to:
receive, from the target cell, another resource configuration associated with the ambient IoT device.

22. The apparatus of claim 10, wherein a plurality of UEs, including the UE, are configured to serve the ambient IoT device, and wherein at least one processor of the one or more processors is configured to cause the network node to:
receive, from the plurality of UEs, a plurality of measurement reports; and
transmit, in association with the plurality of measurement reports and a quantity of the plurality of UEs, a request for another UE to serve the ambient IoT device.

23. The apparatus of claim 22, wherein at least one processor of the one or more processors is configured to cause the network node to:
receive a configuration of a UE minimum quantity threshold, wherein the at least one processor, to cause the network node to transmit the request for the other UE to serve the ambient IoT device, is configured to transmit the request for the other UE to serve the ambient IoT device responsive to the quantity of the plurality of UEs not satisfying the UE minimum quantity threshold.

24. A method of wireless communication performed at a user equipment (UE), comprising:
receiving a backscattered signal associated with an ambient internet of things (IoT) device, wherein the UE is configured to transfer information between the ambient IoT device and a network node; and
initiating a handover of the ambient IoT device.

25. The method of claim 24, wherein initiating the handover of the ambient IoT device includes transmitting a measurement report that configures the network node to transmit an ambient IoT device handover request to a target UE.

26. The method of claim 24, wherein initiating the handover of the ambient IoT device includes transmitting a measurement report that configures the network node to transmit an ambient IoT device handover request to a target cell.

27. The method of claim 24, wherein initiating the handover of the ambient IoT device includes transmitting a measurement report that configures the network node to transmit an ambient IoT device handover request that includes an indication of one or more capabilities of the ambient IoT device or a measurement configuration associated with the ambient IoT device.

28. A method of wireless communication performed at a network node, comprising:
receiving a measurement report from a user equipment (UE) configured to transfer information between an ambient internet of things (IoT) device and the network node; and
transmitting, in accordance with the measurement report, an ambient IoT device handover request.

29. The method of claim 28, wherein the UE is a stationary device and the ambient IoT device is a mobile device.

30. The method of claim 28, wherein the UE is a mobile device and the ambient IoT device is a stationary device or a mobile device.
